(19) United States
(12) Patent Application Publication
(10) Pub. No.: US 2012/0331502 A1
(43) Pub. Date: Dec. 27, 2012

(54) METHOD AND APPARATUS FOR AUTOMATICALLY CREATING MEDIA STREAMS

(76) Inventors: JOHN P. MCINTIRE, Palo Alto, CA (US); Michael Downing, San Francisco, CA (US)

(21) Appl. No.: 13/530,300

(22) Filed: Jun. 22, 2012

Related U.S. Application Data
(60) Provisional application No. 61/499,926, filed on Jun. 22, 2011.

(51) Int. Cl. H04N 21/236

(52) U.S. Cl. 725/32

(57) ABSTRACT

A method for creating a media stream comprising a plurality of individual media segments includes obtaining a first media segment, obtaining a first matching criterion, and automatically associating the first media segment with a second media segment to produce the media stream.

### CROSS REFERENCE TO RELATED APPLICATIONS

This application claims the benefit of U.S. Provisional Patent Application Ser. No. 61/499,926, filed Jun. 22, 2011, which is herein incorporated by reference in its entirety.

### FIELD OF THE INVENTION

The present invention generally relates to the field of media distribution, and more specifically relates to the creation of media streams.

### SUMMARY OF THE INVENTION

A method for creating a media stream comprising a plurality of individual media segments includes obtaining a first media segment, obtaining a first matching criterion, and automatically associating the first media segment with a second media segment to produce the media stream.

### BRIEF DESCRIPTION OF THE DRAWINGS

The teachings of the present invention can be readily understood by considering the following detailed description in conjunction with the accompanying drawings, in which:

FIG. 1 is a schematic diagram illustrating one embodiment of a high-level system for automatically creating media streams, according to the present invention;

FIG. 2 is a schematic diagram illustrating the server of FIG. 1 in more detail;

FIG. 3 is a flow diagram illustrating one embodiment of a method for automatically creating media streams, according to the present invention; and

FIG. 4 is a high level block diagram of the present invention implemented using a general purpose computing device.

### DETAILED DESCRIPTION

In one embodiment, the present invention is a method and apparatus for automatically creating media streams. Embodiments of the invention automatically assemble a media stream comprising a plurality of individual media segments, where the assembly is based at least in part on at least one matching criterion. The matching criterion may be based on observed commonalities between media segments, on user-specified attributes, or on other factors. Once the media stream is assembled, it can be distributed to users.

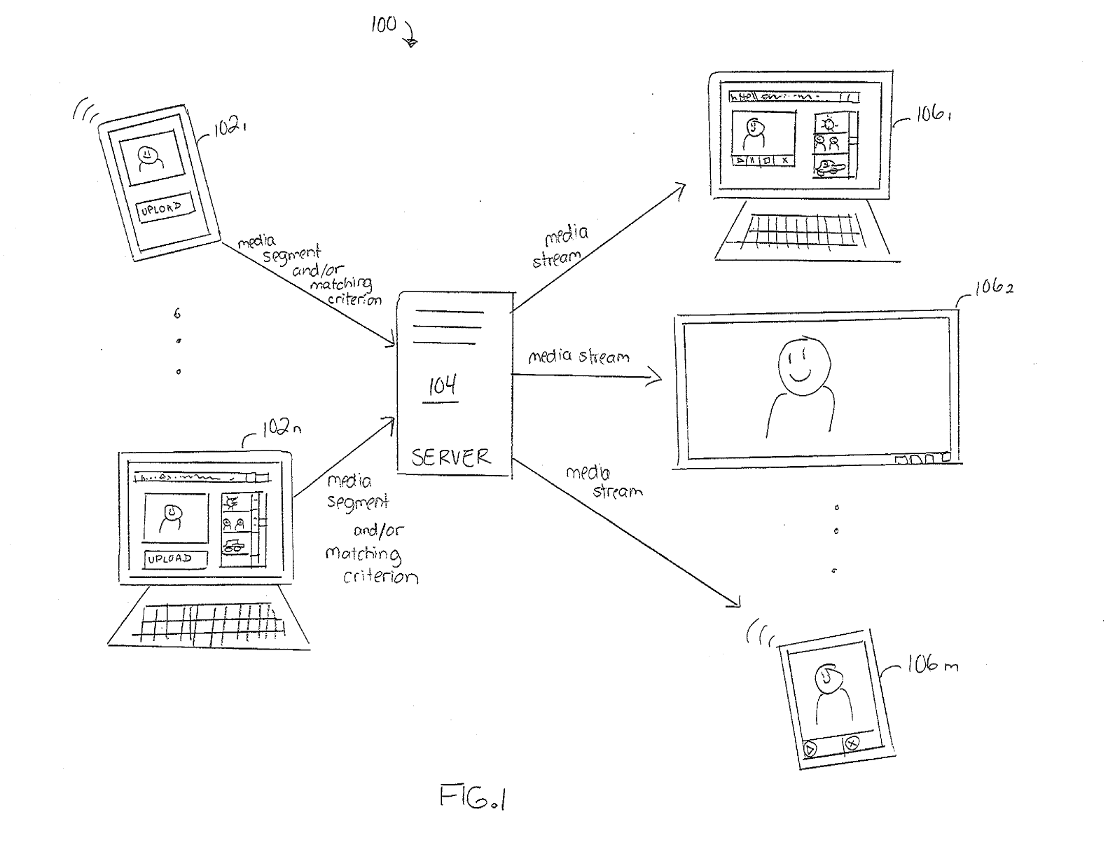

FIG. 1 is a schematic diagram illustrating one embodiment of a high-level system 100 for automatically creating media streams, according to the present invention. As illustrated, the system 100 is a computer network comprising a plurality of user input devices 102₁-102ₙ (hereinafter collectively referred to as “user input devices 102”), at least one server 104, and a plurality of user output devices 106₁-106ₘ (hereinafter collectively referred to as “user output devices 106”). Collectively, the user input devices 102, server 104, and user output devices 106 run an application that automatically creates and distributes media streams based at least in part on user-provided media.

The user input devices 102 comprise computing devices having network interfaces that allow connection to the computer network. Thus, the user input devices 102 may include, for example, personal computers (e.g., desk top computers, laptop computers, tablet computers), cellular telephones, or personal digital assistants, among other devices. Each of the user input devices 102 runs an application that allows a user to create, store, and/or upload (to the server 104) a media segment (e.g., a multimedia file such as a still image, a video, or an audio recording). To this end, at least some of the user input devices 102 may additionally comprise a recording device (e.g., a still camera, a video camera, an audio recorder) and/or editing software that facilitates creation of the media segment. In addition, the application allows the user to transmit to the server 104 a matching criterion for use in associating media segments, as discussed in greater detail below.

The server 104 hosts the application that is run on the user input devices 102. In addition, the server 104 receives the media segments and the matching criteria from the user devices 102 and uses the received data to automatically create media streams, as discussed in greater detail below. Each media stream comprises a plurality of media segments. The media streams are then stored on the server 104 for distribution.

The user output devices 106, like the user input devices 102, comprise computing devices having network interfaces that allow connection to the computer network. In addition, each of the user output devices 106 includes at least one multimedia output (e.g., a display, a speaker, or the like) that allows for consumption of a media stream. Thus, the user output devices 106 may include, for example, personal computers (e.g., desk top computers, laptop computers, tablet computers), cellular telephones, personal digital assistants, Internet-ready televisions, set top boxes, gaming consoles, among other devices. Each of the user output devices 106 runs the application that allows a user receive (from the server 104) and consume a media stream.

In some cases, a computing device may be both a user input device 102 and a user output device 106. For instance, a user could both upload media segments and download or stream media streams on his cellular telephone. Thus, any of the links illustrated in FIG. 1 could be a bidirectional link.

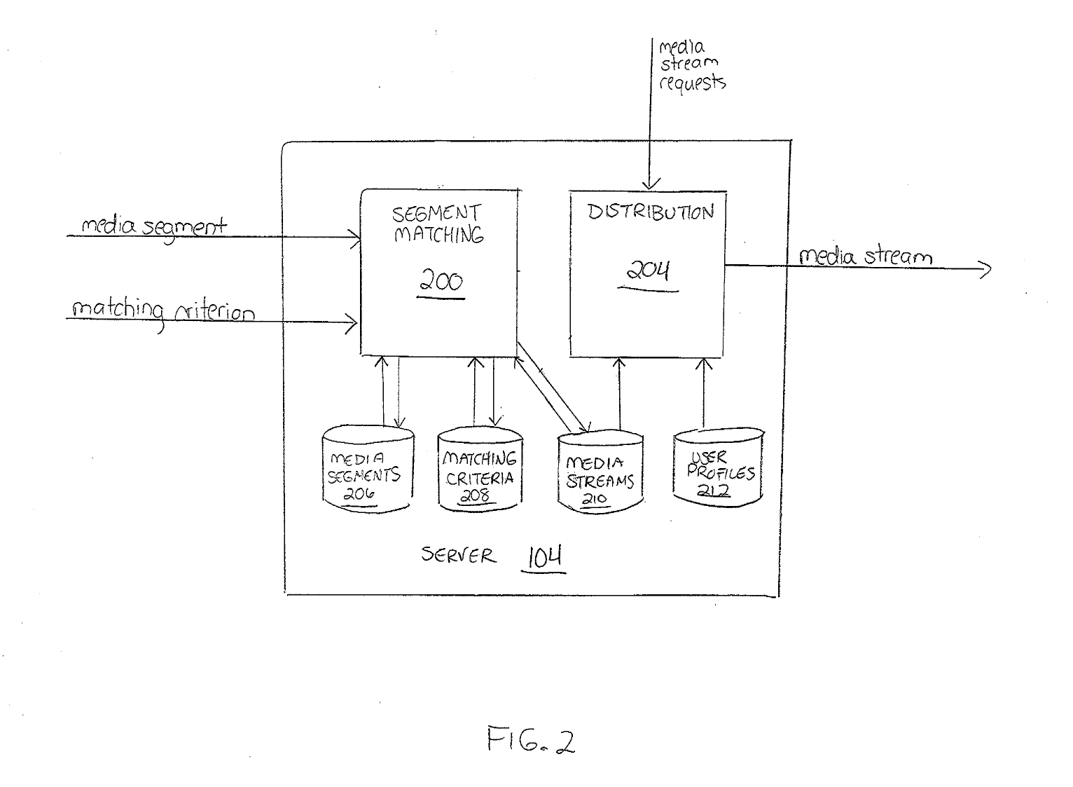

FIG. 2 is a schematic diagram illustrating the server 104 of FIG. 1 in more detail. As illustrated, the server 104 includes a segment matching processor 200, a distribution processor 204, and a plurality of databases, namely, a media segments database 206, a matching criteria database 208, a media streams database 210, and a user profiles database 212.

The segment matching processor 200 receives media segments and matching criteria from the user input devices 102 illustrated in FIG. 1. The segment matching processor 200 stores incoming media segments and matching criteria in the segments database 206 and matching criteria database 208, respectively. In addition, as discussed in greater detail below, the segment matching processor 200 uses the matching criteria stored in the matching criteria database 208 to automatically associate media segments stored in the media segments database 206. This results in the creation of media streams, which are stored by the segment matching processor 200 in the media streams database 210.

The distribution processor 204 is responsible for distributing media streams to the user output devices 106 illustrated in FIG. 1. As discussed in greater detail below, the distribution processor 204 uses media stream requests and/or user profiles stored in the user profiles database 212 to determine which stored media streams from the media streams database 210 should be delivered to which user output devices 106.

As discussed above, the media segments database 206 stores a plurality of media segments. In one embodiment, the media segments that are stored in the media segments database 206 comprise video segments. In a further embodiment, none of the video segments is longer than a defined maximum length or limit (e.g., x seconds). One or more of the video segments may be tagged with metadata that describes the video segment (e.g., when or where the video segment was filmed or uploaded, who submitted the video segment, keywords relating to the content of the video segment, etc.).

The matching criteria database 208 stores matching criteria that are used to associate media segments stored in the media segments database 206. A matching criterion may be explicitly provided by a user (e.g., “Please stream video segments filmed by user X.”) or may be implicitly inferred by the server 104 or a human administrator based on metadata associated with the media segments (e.g., a large number of video segments may have been submitted from an event that is currently in progress, such as a baseball game, or may be tagged with similar keywords).

The media streams database 210 stores media streams, each media stream comprising a plurality of associated media segments. For instance, a media stream may comprise a dozen video segments filmed by a particular user (e.g., user X). Media streams stored in the media streams database 210 may be updated at any time to include new media segments. For instance, the media stream comprising the dozen media segments filmed by user X may be updated in real time to include a newly received video segment filmed by user X.

The user profiles database 212 stores user profiles, which describe users of the system 100. For instance, a user profile may include a summary of all media streams and/or media segments submitted by or otherwise associated with user X. In addition, the user profile may include a summary of other media streams to which user X subscribes. The user profile may also generally describe user X's preferences, such as subjects in which user X is interested. Thus, the user profile may be used to match a new media segment received from user X with one of user X's existing media streams or media segments. Additionally, the user profile may be used to alert user X to the creation of a new media stream that is associated with one of user X's subscriptions, that matches user X's preferences, or that relates to a media segment and/or media stream previously submitted by user X. At least some of the information in a user profile may be made available to other users, for example in the form of a web page. In one embodiment, a user may specify which portions of his user profile he wishes to make available to others and/or which other users have access to his user profile.

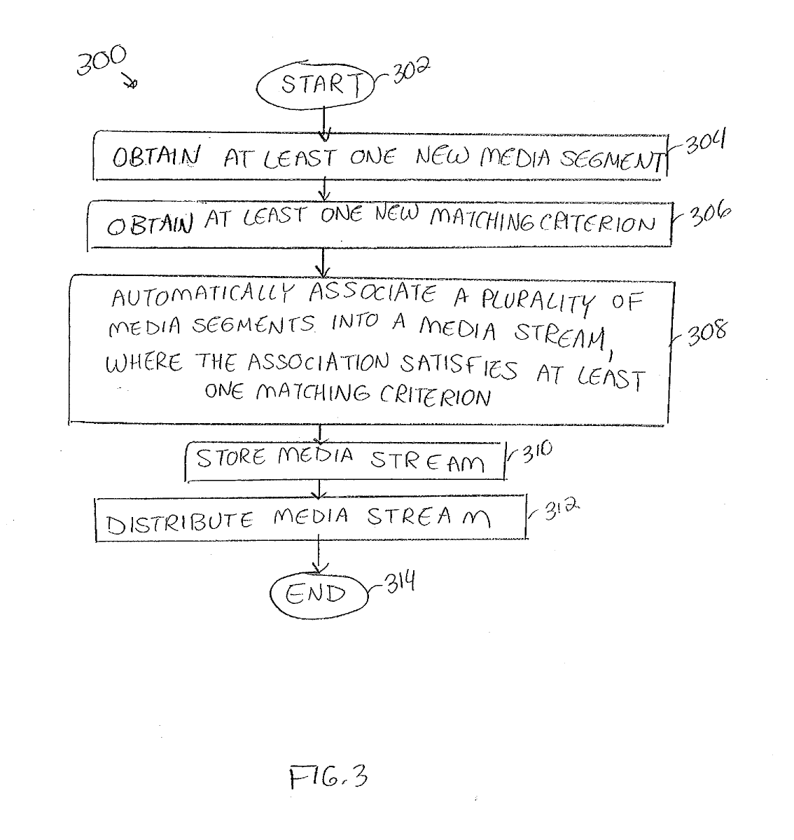

FIG. 3 is a flow diagram illustrating one embodiment of a method 300 for automatically creating media streams, according to the present invention. The method 300 may be implemented, for example, at the server 104 illustrated in FIGS. 1 and 2. As such, reference is made in the discussion of the method 300 to various elements illustrated in FIG. 2. It will be appreciated however, that the method 300 is not limited to implementation with the server configuration illustrated in FIG. 2, and that such references are made largely to facilitate explanation.

The method 300 is initialized at step 302 and proceeds to step 304, where the server 104 obtains at least one new media segment. For instance, the new media segment may comprise a video segment uploaded in substantially real time by user X, where the video segment was filmed at a baseball game that is currently in progress. In one embodiment, step 304 includes a step of storing the new media segment in the media segments database 206.

In step 306, the server 104 obtains at least one new matching criterion. For instance, the new matching criterion may be extracted from the new video segment (e.g., from a tag or other metadata associated with the new video segment or via other processing such as image and/or sound processing). Alternatively, the new matching criterion may be received from an on-demand request from a user (e.g., user Y) or from a human administrator. Thus, the method 300 may involve human intervention at certain times. For example, user Y may request that a media stream be assembled that comprises video segments filmed during the baseball game that is currently in progress. In one embodiment, step 306 includes a step of storing the new matching criterion in the matching criteria database 208.

In step 308, the segment matching processor 200 automatically associates a plurality of media segments into a media stream. The plurality of media segments may or may not include the new media segment. The association satisfies at least one matching criterion, which may or may not include the new matching criterion. That is, all of the media segments making up the media stream satisfy the at least one matching criterion. For instance, if the matching criterion is a request for video segments filmed during the baseball game that is currently in progress, then the resultant media stream will comprise a plurality of video segments filmed during the baseball game.

In one embodiment, user permission may be solicited before associating a media segment submitted by the user with a media stream. For instance, the server 104 may send a recommendation to the user recommending that the media segment be associated with the media stream and seeking approval to make the association.

In yet another embodiment, the segment matching processor 200 may associate relevant advertising material and/or other related content with the media stream. For example, if the media stream comprises a plurality of video segments filmed during the baseball game as discussed above, the media stream might include the home team's schedule or an advertisement that allows viewers to purchase tickets to an upcoming game.

In step 310, the media stream is stored in the media streams database 210. In one embodiment, the media stream may tagged with keywords or other metadata describing the media stream.

In step 312, the media stream is distributed by the distribution processor 204. Distribution of the media stream may comprise pushing the media stream or a hyperlink to user output devices operated by users whose preferences and/or subscriptions (e.g., as described in their user profiles) match the media stream. Alternatively, distribution to these users may involve simply sending an alert that informs the users that the media stream is available (e.g., by accessing a particular web site). In yet another embodiment, where the media stream comprises media segments received from a particular geographic location, the media stream may be distributed to users who have indicated that they are currently at or near that particular geographic location.

The method 300 terminates in step 314.

The present invention therefore assembles, in substantially real time, media streams comprising a plurality of media segments. The media segments may be submitted by the same user or by a plurality of different users. For instance, the media stream might comprise a stream of short video segments submitted by a particular celebrity or public figure. Alternatively, the media stream might comprise a stream of short video segments submitted by several different users attending the same event.

As discussed above, media segments may be associated with each other based any one or more of a number of various matching criteria, including, but not limited to: the location from which the media segments were submitted or created, the time period during with the media segments were created and/or uploaded, the source(s) of the media segments (i.e., submitting users), the media segments that the most users have viewed, the media segments that have been rated most highly by viewers, the contents of the media segments (e.g., subject matter), social relationships associated with the media segments (e.g., media segments depicting friends, family, or the like), or information from third-party sources.

The matching criteria may be explicitly specified (e.g., user-defined) or implicitly inferred (e.g., observed through metadata). For instance, the server 104 (or a human administrator with access to the server 104) may note that a plurality of video segments was received from roughly the same geographic location within a defined period of time. Alternatively, users may request that their video segments be associated with video segments submitted by certain other users.

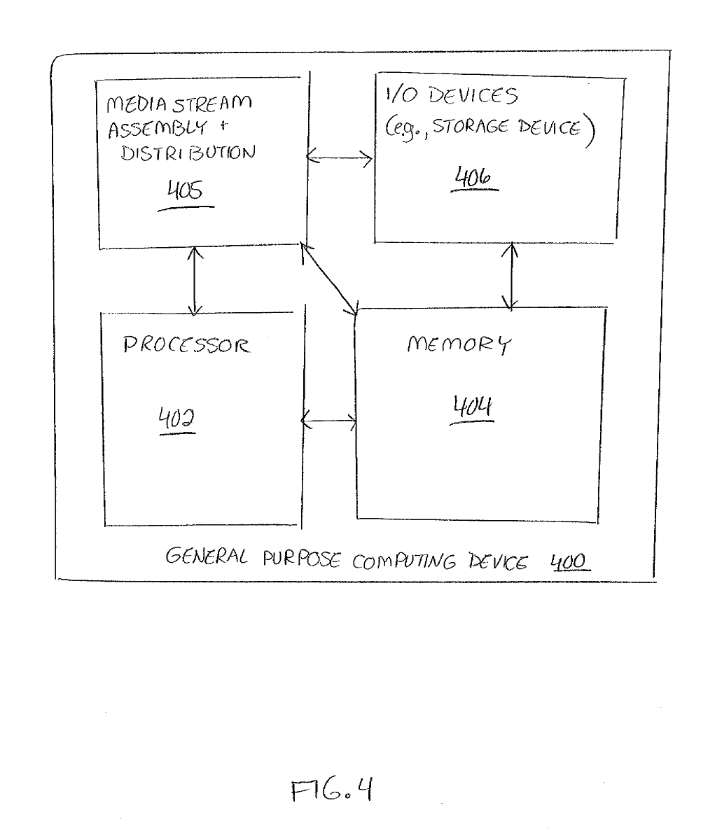

FIG. 4 is a high level block diagram of the present invention implemented using a general purpose computing device 400. It should be understood that embodiments of the invention can be implemented as a physical device or subsystem that is coupled to a processor through a communication channel. Therefore, in one embodiment, a general purpose computing device 400 comprises a processor 402, a memory 404, a media stream assembly and distribution module 405, and various input/output (I/O) devices 406 such as a display, a keyboard, a mouse, a modem, a microphone, speakers, a touch screen, an adaptable I/O device, and the like. In one embodiment, at least one I/O device is a storage device (e.g., a disk drive, an optical disk drive, a floppy disk drive).

Alternatively, embodiments of the present invention (e.g., media stream assembly and distribution module 405) can be represented by one or more software applications (or even a combination of software and hardware, e.g., using Application Specific Integrated Circuits (ASIC)), where the software is loaded from a storage medium (e.g., I/O devices 406) and operated by the processor 402 in the memory 404 of the general purpose computing device 400. Thus, in one embodiment, the media stream assembly and distribution module 405 for automatically creating media streams described herein with reference to the preceding Figures can be stored on a non-transitory computer readable medium (e.g., a tangible or physical article such as a RAM, a magnetic or optical drive or diskette, and the like).

It should be noted that although not explicitly specified, one or more steps of the methods described herein may include a storing, displaying and/or outputting step as required for a particular application. In other words, any data, records, fields, and/or intermediate results discussed in the methods can be stored, displayed, and/or outputted to another device as required for a particular application. Furthermore, steps or blocks in the accompanying Figures that recite a determining operation or involve a decision, do not necessarily require that both branches of the determining operation be practiced. In other words, one of the branches of the determining operation can be deemed as an optional step.

Although various embodiments which incorporate the teachings of the present invention have been shown and described in detail herein, those skilled in the art can readily devise many other varied embodiments that still incorporate these teachings.

What is claimed is:

1. A method for creating a media stream comprising a plurality of individual media segments, the method comprising:
obtaining a first media segment;
obtaining a first matching criterion; and
automatically associating the first media segment with a second media segment to produce the media stream.

2. The method of claim 1, wherein the plurality of individual media segments is a plurality of individual video segments.

3. The method of claim 2, wherein none of the plurality of individual video segments is longer than a defined maximum length.

4. The method of claim 1, wherein the first matching criterion is explicitly obtained from a user.

5. The method of claim 1, wherein the first matching criterion is inferred from metadata associated with at least one of the first media segment and the second media segment.

6. The method of claim 1, wherein the first matching criterion specifies a keyword associated with the first media segment and the second media segment.

7. The method of claim 6, wherein the keyword describes a content of the first media segment and the second media segment.

8. The method of claim 1, wherein the first matching criterion specifies a location from which the first media segment and the second media segment are received.

9. The method of claim 1, wherein the first matching criterion specifies a time period during which the first media segment and the second media segment are created.

10. The method of claim 1, wherein the first matching criterion specifies a time period during which the first media segment and the second media segment are received.

11. The method of claim 1, wherein the first matching criterion specifies a creator of the first media segment and the second media segment.

12. The method of claim 1, wherein the first matching criterion specifies a user rating associated with the first media segment and the second media segment.

13. The method of claim 1, wherein the first matching criterion specifies a number of times that the first media segment and the second media segment have been accessed.

14. The method of claim 1, wherein the first matching criterion specifies a relationship between a source of the first media segment and a source of the second media segment have been accessed.

15. The method of claim 1, wherein the matching criterion is obtained from a source of at least one of the first media segment and the second media segment.

16. The method of claim 1, wherein the first media stream comprises a video recorded by a first attendee of an event, and the second media stream comprises a video recorded by a second attendee of the event who is different from the first attendee.

17. The method of claim 1, wherein the matching criterion is obtained from a request received from a user who wishes to access the media stream.

18. The method of claim 1, further comprising:
adding related content other than the first media segment and the second media segment to the media stream prior to distributing the media stream.

19. A tangible computer readable medium containing an executable program for creating a media stream comprising a plurality of individual media segments, where the program performs operations comprising:
obtaining a first media segment;
obtaining a first matching criterion; and
automatically associating the first media segment with a second media segment to produce the media stream.

20. A system for creating a media stream comprising a plurality of individual media segments, comprising:
a processor; and
a computer readable medium containing an executable program that causes the processor to perform operations comprising:
obtaining a first media segment;
obtaining a first matching criterion; and
automatically associating the first media segment with a second media segment to produce the media stream.
